(19) United States
(12) Patent Application Publication
(10) Pub. No.: US 2005/0159593 A1
(43) Pub. Date: Jul. 21, 2005

(54) Method for deproteinization of chitosan

(76) Inventors: Henryk Struszczyk, Zgierz (PL); Magdalena Kucharska, Lodz (PL); Antoni Niekraszewicz, Lodz (PL); Alojzy Urbanowski, Lodz (PL); Ewa Wesolowska, Lodz (PL); Danuta Ciechanska, Lodz (PL)

Correspondence Address: ROBERT DEBERARDINE;ABBOTT LABORATORIES, 100 ABBOTT PARK ROAD, DEPT. 377/AP6A, ABBOTT PARK, IL, 60064-6008, US

(21) Appl. No.: 10/501,174

(22) PCT Filed: Jan. 9, 2003
(86) PCT No.: PCT/IB03/00074

(30) Foreign Application Priority Data
Feb. 7, 2002 (PL) P.352079

(51) Int. Cl. C08B 37/08

(52) U.S. Cl. 536/124; 536/1.11

(57) ABSTRACT

Methods for deproteinizing chitosan are provided. Proteins are dissolved in aqueous solution under intensive agitation. Precipitated agglomerated microcrystalline product Is subject to aqueous acidic or basic salt solution, from which dissolved proteins can be removed. Residual product is deproteinized chitosan.

### FIELD OF THE INVENTION

The invention concerns a method for deproteinization of chitosan.

### BACKGROUND OF THE INVENTION

“Journal of Applied Polymer Science”, vol. 2, p. 380, 1980; “Fishery Technology”, vol. 11, p. 50, 1974; “Carbohydrate Research”, vol. 38, p. 35, 1974, “Journal of Food Science Technology”, vol. 12, p. 187, 1975; “Journal of Organic Chemistry”, vol. 27, p. 161, 1962; “Biotechnology & Bioengineering”, vol. 20, p. 1931, 1978; “Journal of Agriculture and Food Chemistry”, vol. 37, p. 5-75, 1989; “Journal of Agriculture and Food Chemistry”, vol. 39, p. 1527, 1991; “Acta Polymer”, vol. 45, p. 41, 1994; “Food Biotechnology”, vol. 7, p. 253, 1993 and U.S. Pat. Nos. 3,533,940, 3,862,122, 3,922,260, 4,066,735, 4,195,175, and 4,199,496 and Polish Patent 119,931 and 160,714 teach methods to reduce the protein content in chitin and chitosan. These methods are based on the treatment of shells of crustaceans and insects with aqueous alkali such as sodium hydroxide, potassium hydroxide, calcium hydroxide, or their salts as sodium carbonate, sodium hydrogen carbonate, sodium sulfite, sodium hydrogen sulfite, sodium sulfide or sodium phosphate, with concentration of 0.5-10.0 wt % at temperature of 20-150° C. for 1-72 h. These well—known methods allow the reduction of the protein content in chitin and chitosan, however, they are not able to eliminate proteins from chitin and chitosan.

U.S. Pat. Nos. 5,623,064 and 5,624,679 teach methods to produce chitin and chitosan with high purity without proteins. These methods are based on mechanical or enzymatic treatment of microalgae strain of Coscinodiscus genus, Cyclotella genus and Tzalassiosira genus. Microalgae biomass is treated by aqueous solution of hydrochloric acid at temperature 70° C., water and ethyl alcohol whereas the proteins are removed by treatment with surfactants such as sodium dodecylsulphonate. This well—known method is characterized by low yield and the tendency of polyaminosaccharides toward hydrolitic degradation in acidic medium. This method is not useful for deproteinization of chitin and chitosan originated from sources like the shells of crustaceans and insects.

U.S. Pat. No. 5,053,113 teaches electrochemical deproteinization and demineralization of raw materials containing chitin. These chitin based raw materials are treated with 0.1-2.0% aqueous sodium hydroxide using electric current of 4-11 A and voltage of 15-50V for 10-45 min.

U.S. Pat. No. 6,310,188 teaches a method to produce chitin and chitosan by transformation of crustacean shells into amorphous form. The crustacean shells are heated at 78° C. and drastically cooled in liquid nitrogen. The amorphous shells are used to prepare chitin, and may be deproteinized with aqueous sodium hydroxide.

These well—known methods do not allow production of chitin with protein content lower than 10-20 ppm.

### SUMMARY OF THE INVENTION

Disclosed are methods for deproteinizing chitosan by precipitating microcrystalline chitosan from aqueous solution of chitosan.

### DESCRIPTION OF TEE INVENTION

The method for deproteinization of chitosan according to the invention, consists in that the chitosan, containing proteins dissolved in aqueous solutions of acids such as hydrochloric, acetic or lactic, with polymer concentration not lower than 0.001 wt %, preferably 0.5-2.0 wt %, is agglomerated using aqueous solutions of base or/and its salts for not less than 1 minute, preferable 30-120 minutes, with intensive agitation at 100-1000 rpm. Precipitated agglomerated microcrystalline product is subjected to aqueous base or basic salt solution with concentration not lower than 0.1 wt %, preferably 1-10 wt %, for time ranged from 1 minute to 100 hours. Then, the aqueous base or basic salt solution containing dissolved proteins is removed from reaction medium and the residual product is washed by water and/or alcohol, preferably ethyl alcohol, to remove all contaminants and the resulted chitosan is concentrated and possibly dried by well-known methods.

The chitosan agglomeration process according to the invention can be carried out in two steps. The first step involves addition of aqueous solution of base or/and its salts to obtain a reaction medium pH=6.0—6.5. Then a second aqueous solution of base or/and its salts is added. The ratio of concentration of alkali in the first basic solution relative to that in the second alkali solution is 1:0.1 to 1:0.9.

Aqueous solutions of sodium or potassium hydroxide or/and their salts such as sodium or potassium carbonate are used in the method according to the invention. The aqueous solution of base or/and its salts containing dissolved proteins in the method according to invention is removed from reaction medium by filtration, ultrafiltration, sedimentation or centrifugation.

Deproteinization of chitosan in accordance to the invention is achieved by removing proteins from agglomerated microcrystalline chitosan by their dissolution in aqueous alkali. Specific structure of agglomerated chitosan, including its porosity, water retention value higher than 500% as well as developed intrinsic surface, microcapillary and capillary system, support alkali diffusion into chitosan structure, resulting in protein dissolution. A method according to the invention destroys the stable complex connections of proteins with initial chitosan by its dissolution followed by agglomeration. A two stage agglomeration allows production of the agglomerated chitosan with special developed intrinsic surface accessible for alkali penetration and protein dissolution.

A benefit of the method according to the invention is to maximize removal of proteins from developed structure of chitosan by treatment with aqueous basesor/and their salts as well as by washing using water with reduced reaction medium of agglomerated chitosan. This process supports removal of the protein from chitosan structure.

The structure of resultant microcrystalline chitosan is specially susceptible on solvent exchange processes, including alkali treatment acting positively for protein removal.

Chitosan deproteinized according to the invention is characterized by high degree of purity and protein content lower than 10 ppm. This chitosan is widely applied in medicine, pharmacy or biotechnology.

The method according to the invention is illustrated with following examples, which do not limit its range of application.

### EXAMPLE I

99 weight parts of 0.4 wt % aqueous hydrochloric acid solution and 1 weight part of chitosan flakes with viscometric average molecular weight M_{V}=796 kD, deacetylation degree DD=85.6%, water retention value 76.6%, moisture content 11.1%, ash content 0.21% and protein content of 350 ppm were introduced into reactor equipped with agitator and cooling jacket. Chitosan was dissolved for 2 h with agitation of 120 rpm, then the solution was filtered on the frame filter, obtaining 96 weight parts of solution containing 0.99 wt % of chitosan. This solution was transferred into a reactor equipped with high speed agitator and cooling jacket where this solution with agitation of 480 rpm was treated with gradual addition of 53.5 weight parts of 0.75% aqueous solution of sodium hydroxide to obtain a reaction medium pH=8.20 and precipitation of agglomerated microcrystalline product in a form of dispersion. The resulting dispersion was concentrated on the nutsche filter to obtain 40 weight parts of agglomerates that were transferred to a previous reactor containing 80 weight parts of 5.0% aqueous sodium hydroxide. A process of protein removal was carried out for 3 h at temperature 20° C. with agitation of 30 rpm The dispersion was next concentrated on the nutsche filter obtaining 40 weight parts of chitosan dispersion. This dispersion was transferred again to the reactor containing 40 weight parts of demineralized water with pH=6.50. A content of reactor was homogenized for 15 minutes and filtered with estimation of protein concentration in filtrate and chitosan dispersion. A chitosan dispersion was washed 20 times on the nutsche filter using demineralized water to eliminate the presence of protein in filtrate and to obtain the reaction medium pH=7.35 in the microcrystalline agglomerate.

30 weight parts of protein—free chitosan agglomerates containing 3.15 wt % of polymer with M_{V}=750 kD, DD=680% and ash content 0.12% were obtained.

### EXAMPLE II

99 weight parts of 2.0% aqueous solution of acetic acid and 1.2 weight parts of chitosan flakes with properties as in Example I were introduced in the reactor as in Example I. Chitosan was dissolved for 3 h with agitation rate of 120 rpm, then the chitosan solution was filtered on the frame filter to obtain 96 weight part of solution containing 1.15% of chitosan. This solution was transferred into reactor with high speed agitator and cooling jacket and 88 weight parts 1.5 aqueous sodium hydroxide solution was gradually added to the reactor with continuous agitation with 500 rpm to obtain a reaction medium pH=8.20. Agglomerated microcrystalline product in a form of dispersion. This dispersion was concentrated on the nutsche filter precipitated to obtain 40 weight parts of agglomerates that were transferred to a reactor equipped with low speed agitator and 80 weight parts 5.0% aqueous sodium hydroxide. Treatment of chitosan agglomerate was carried out for 3 h at temperature 20° C. with agitation rate 30 rpm. Then, the mixture was concentrated on the nutsche filter obtaining 40 weight parts of chitosan dispersion. This dispersion was mixed for 15 minutes with 40 weight parts of demineralized water with pH=6.50 and next a content of reactor was filtered with estimation of protein concentration in filtrate and chitosan agglomerate. The washing process by demineralized water was repeated on the nutsche filter 20 times to eliminate the protein in filtrate and obtain the chitosan agglomerate reaction pH=7.40.

28 weight parts of protein—free chitosan agglomerates were obtained with polymer content 3.41 wt %, M_{V}=760 kD, DD=85.6%, WRV=820% and ash content 0.12%.

### EXAMPLE III

99 weight parts of aqueous lactic acid solution and I weight part of chitosan powder with M_{V}=400 kD, DD=79.2%, moisture content 5.68%, ash content 1.3%, WRV=244% and protein content of 600 ppm was agitated with 100 rpm for 2.5 h in the reactor as in Example I. This solution was filtered on the frame filter to obtain 95 weight parts of chitosan solution containing 0.98% of polymer. This filtered solution was transferred to a reactor equipped with high speed agitator and cooling jacket and 53.56 weight parts of 0.5% aqueous potassium hydroxide solution was added gradually with agitation with 400 rpm to obtain a reaction medium pH=8.00 and precipitation of agglomerated product in a microcrystalline form. This dispersion was concentrated using filtration centrifuge to obtain 230 weight parts of chitosan agglomerate, which was transferred to a reactor equipped with agitator containing 60 weight parts 5.0% aqueous potassium hydroxide solution then a deproteinization was carried out for 5 h with agitation rate of 30 rpm at temperature 20° C. The resulting dispersion was concentrated using centrifuge to obtain 30 weight parts of chitosan agglomerate dispersion. This chitosan dispersion was transferred again to a reactor containing 30 weight parts of demineralized water with pH=6.50. The mixture was agitated for 15 minutes and next filtered with estimation of protein concentration in filtrate and chitosan agglomerate. The washing process by demineralized water was repeated on the filtering antifuge 22 times to obtain the chitosan agglomerate reaction of pH=7.30.

33 weight parts of chitosan agglomerates with polymer content 2.92 wt %, M_{V}=370 kD, DD=79.2%, ash content 0.22%, WRV=1050% and protein content lower than 10 ppm were obtained. This product is acceptable for medical and pharmaceutical uses.

### EXAMPLE IV

99 weight parts of 0.4% aqueous hydrochloric acid solution and 1 weight part of chitosan flakes with M_{V}=850 kD, DD=83.4%, moisture content 13.0%, ash content 0.59%, WRV=139% and protein content of 1750 ppm were agitated for 2 h with 280 rpm in the reactor as in Example I. The resulting solution was filtered on the frame filter to obtain 96 weight parts of chitosan solution containing 0.99 wt % of polymer. This chitosan solution was transferred to the reactor equipped with high speed agitator and cooling jacket and 43.0 weight parts of 0.75% aqueous sodium hydroxide was gradually added with agitation rate of 480 rpm to obtain a reaction medium pH=6.46, then 16.0 weight parts of 0.50% aqueous sodium hydroxide solution was gradually added with the same agitation rate to obtain a medium reaction pH=7.99 and precipitation of agglomerated product in the microcrystalline form. The resulting dispersion was concentrated on the filtration nutsche to obtain 39 weight parts of chitosan agglomerates. These agglomerates were transferred to the reactor (equipped with an agitator) containing 78 weight parts 5.0% aqueous sodium hydroxide; deproteinization was carried out for 5 h at temperature 20° C. with agitation rate 30 rpm. This mixture was concentrated on the nutsche filter, transferred again to the reactor containing 40 weight parts of demineralized water with pH=6.50 to agitate for 15 minutes. A mixture was filtered on the nutsche filter with estimation of protein content in filtrate and chitosan agglomerates. The washing process by demineralization was repeated 20 times to obtain a reaction medium pH=7.35.

30 weight parts of chitosan agglomerates distinguished by protein content of 350 ppm were obtained in this stage. Deproteinization was repeated twice using 30 weight parts 1.0% aqueous sodium hydroxide with agitation rate 30 rpm for 3 h at temperature 20° C. The resulting mixture was concentrated to obtain 35 weight parts of chitosan dispersion that was homogenized for 15 minutes with 35 weight parts of demineralized water with pH=6.50. The washing process with demineralized water on the nutsche filter was repeated 12 times to obtain the agglomerated chitosan reaction of pH=7.30.

The final product was 30 weight parts of chitosan agglomerates having a polymer content 3.15%, M_{V}=770 kD, DD=83.4%, WRV=900%, ash content 0.15% and protein content lower than 10 ppm. This product is acceptable for medical and pharmaceutical uses.

### EXAMPLE V

1.0 weight parts of chitosan flakes with M_{V}=240 kD, DD=84.3%, moisture content 6.76%, ash content 1.1%, WRV=140% and protein content 728 ppm and 49 weight parts of 0.4% aqueous hydrochloric acid solution were introduced to the reactor as in Example I. Dissolution was carried out for 2.5 h with an agitation rate of 120 rpm, then resulting solution was filtered on the frame filter to obtain 48.5 weight parts of chitosan solution containing 1.92% of polymer. This chitosan solution was transferred to the reactor, equipped with high speed agitator and cooling jacket, and 26.5 weight parts aqueous sodium hydroxide solution was gradually added with agitation rate 480 rpm to obtain a reaction medium pH=8.20 and precipitation of chitosan agglomerates in a micro crystalline form. This dispersion was concentrated on the nutsche filter to obtain 35 weight parts of chitosan agglomerate dispersion that was transferred to the reactor containing 70 weight parts 5.0% aqueous sodium hydroxide solution. The mixture obtained was agitated at 30 rpm for 3 h at 20° C., then the dispersion was concentrated on the nutsche filter to obtain 40 weight parts of chitosan dispersion. This dispersion was homogenized with 40 weight parts of demineralized water with pH=6.50 for 15 minutes. The dispersion was then filtered on the nutsche filter with estimation of protein content in filtrate and chitosan dispersion. A washing process by demineralized water was repeated 20 times to eliminate proteins and obtain a chitosan dispersion reaction pH=7.35.

The final product was 3.0 weight parts of chitosan agglomerates containing 3.20% polymer characterized with M_{V}=230 kD, DD 84.3%, ash content 0.25%, WRV=750% and protein content lower than 10 ppm were obtained. This product is acceptable for medical and pharmaceutical use.

### EXAMPLE VI

99 weight parts of 2.0% aqueous solution of acetic acid and 1.2 weight parts of chitosan flakes with properties as in Example I was agitated for 3 h with 120 rpm in the reactor as in Example I. The dissolved chitosan was filtered on a frame filter to obtain 96 weight parts of chitosan solution containing 1.15% of polymer. This solution was transferred to the reactor, equipped with high speed agitator and cooling jacket, and 88 weight parts of 1.5% aqueous solution of sodium hydroxide and sodium carbonate, in a weight ratio of 2:1, was gradually added with agitation rate 500 rpm to obtain a reaction medium of pH=8.20 and precipitation of chitosan agglomerates in a microcrystalline form. The resulting dispersion was concentrated by centrifugation to obtain 40 weight parts of chitosan agglomerates. This chitosan form was introduced into the reactor equipped with agitator containing 80 weight parts 7.5% aqueous sodium hydroxide and deproteinization was carried out for 2 h at 20° C. with agitation rate 30 rpm. The mixture was concentrated on the nutsche filter to obtain 40 weight parts of chitosan dispersion that was homogenized for 15 minutes with 80 weight parts of demineralized water with pH=6.50. A mixture was then filtered with estimation of protein presence in filtrate and chitosan dispersion. A washing process by demineralized water was repeated 20 times to eliminate the protein presence in filtrate and to obtain the chitosan agglomerate reaction pH=7.40 The product was washed by 75 weight parts of ethyl alcohol to obtain pH=7.20.

The final product was 28 weight parts of chitosan agglomerates with polymercontent 3.41%, M_{V}=220 kD, DD=84.3%, ash content 0.15%, WRV=820% and protein content lower than 10 ppm were obtained. This product is acceptable for medical and pharmaceutical uses.

### EXAMPLE VII

1 weight part of chitosan flakes with properties as in Example 1 and 99 weight parts of 0.4% aqueous hydrochloric acid solution were introduced into the reactor as in Example I. Dissolution was carried out for 2 h with agitation rate 120 rpm, then the solution was filtered on the frame filter to obtain 96 weight parts of chitosan solution containing 0.99% polymer. This solution was transferred to the reactor, equipped with high speed agitator and cooling jacket, and 43 weight parts 0.75% aqueous sodium hydroxide solution was gradually added with agitation rate 480 rpm to obtain a reaction medium of pH=6.46 and 21.7 weight parts of 0.50% aqueous sodium hydroxide was added in the same conditions to obtain a medium reaction of pH=8.03 and precipitation of chitosan agglomerates in a microcrystalline form. The dispersed chitosan agglomerate solution was concentrated on the nutsche filter to obtain 40 weight parts of product that was introduced into reactor, equipped with agitator, containing 80 weight parts 5.0% aqueous sodium hydroxide solution. Deproteinization was carried out for 3 h at temperature 20° C. with agitation rate of 30 rpm. This dispersion was concentrated on the nutsche filter to obtain 40 weight parts of chitosan dispersion, which was homogenized for 15 minutes with 40 weight parts of demineralized water with pH=6.50. The resulting mixture was filtered on the nutsche filter with estimation of protein presence in filtrate and chitosan dispersion. The washing process by demineralized water was repeated 20 times on the nutsche filter to eliminate a residual protein and to obtain a chitosan agglomerate reaction of pH=7.35. This product was concentrated by centrifugation.

The final product was 30 weight parts of protein—free chitosan agglomerates with polymer content 3.15%, M_{V}=750 1(D, DD=85.6%, WRV=800% and ash content 0.12 were obtained.

1. A method for deproteinizing chitosan, comprising the steps of:
a) reacting an acidic solution of chitosan, said chitosan containing proteins ≧0.001 wt %, with an aqueous base to precipitate microcrystalline chitosan; and
b) separating said precipitated microcrystalline chitosan from dissolved proteins to produce a microcrystalline chitosan having a protein content ≦10 ppm.

2. A method according to claim 1, wherein said acidic solution of chitosan comprises an acid selected from the group consisting of hydrochloric acid, acetic acid and lactic acid.

3. A method according to claim 1, wherein said aqueous base is selected from the group consisting of sodium hydroxide, potassium hydroxide, sodium carbonate, and potassium carbonate.

4. A method according to claim 1, wherein said reacting step is carried out at 6.0≦pH≦6.5.

5. A method according to claim 1, wherein said reacting step further comprises adding a first aqueous basic solution to reach 6.0≦pH≦6.5 and then adding a second aqueous basic solution, wherein the concentration ratio of alkali in said first aqueous basic solution to said second aqueous basic solution is between 1:0.1 to 1:0.9.

6. A method according to claim 1, wherein said separating step is carried out using a method selected from the group consisting of filtration, ultrafiltration, sedimentation and centrifugation.

7. A composition of matter, comprising a chitosan prepared according to a method according to claim 1.
